(19) United States
(12) Patent Application Publication
(10) Pub. No.: US 2018/0153009 A1
(43) Pub. Date: May 31, 2018

(54) Drive circuit for LED lamps adapted to replace high-intensity discharge lamps

(71) Applicant: MATIC Lighting Technology (Shanghai) Co., Ltd., Shanghai (CN)

(72) Inventors: Jianchang XIONG, Shanghai (CN); Qingwu MAO, Shanghai (CN)

(21) Appl. No.: 15/822,526

(22) Filed: Nov. 27, 2017

(30) Foreign Application Priority Data
Nov. 29, 2016 (CN) 201621289897.5

(51) Int. Cl. H05B 33/08

(52) U.S. Cl. CPC H05B 33/0809; H05B 33/089

(57) ABSTRACT

A drive circuit is configured to electrically connect a LED lamp module to a ballast, which is a high-intensity discharge lamp constant-wattage autotransformer ballast. The drive circuit has a bridge rectifier, and a reactor element electrically connected to the bridge rectifier, wherein the bridge rectifier consists of four rectifiers connected in a loop. The bridge rectifier has two AC inputs and two DC outputs. The DC outputs are connected to two ends of an LED lamp module. The two AC inputs are electrically connected to the outputs of the ballast with a series inductor, a series capacitor or a parallel inductor.

### CROSS-REFERENCE TO RELATED APPLICATION

This application claims priority to Chines application No. CN 201621289897.5, filed Nov. 29, 2016, which is hereby incorporated by reference in its entirety.

### TECHNICAL FIELD

The present invention generally relates to the field of lighting and, more specifically, relates to a drive circuit for LED lamps adapted to replace high-intensity discharge lamps.

### BACKGROUND OF THE INVENTION

Gas-discharge lamps are lamps that emit light through a hybrid discharge involving gas, metal vapor, or several types of gas and metal vapors. They provide an electrical light source that converts the electrical energy discharged in a gas into light. A high-intensity discharge (HID) lamp is a type of gas-discharge lamp that emits light resulting from an arc discharge within an arc tube filled with an inert gas or metal vapor. The selection of an appropriate light-emitting substance can cause the radiation spectrum to peak at the desired wavelength; several such light-emitting substances can be used to achieve an optimal composite spectrum. This type of lamp provides high efficiency and a long service life.

High-intensity discharge (HID) lamps include metal halide lamps, high-pressure sodium lamps, high-pressure mercury lamps, and xenon arc lamps, etc.

There are two types of metal halide lamps, one being a quartz metal halide lamp that employs an arc tube made of quartz, the other being a ceramic metal halide lamp that employs an arc tube made of translucent aluminum oxide ceramic. Metal halide lamps are one of the world's optimal types of light source. Metal halide lamps offer high efficiency (65-140 lm/w), long service life (5000-20000 h), good color rendering (Ra65-95), a compact structure, and stable performance; they constitute a light source approximating sunlight, and are widely used for indoor lighting at sports facilities, exhibition centers, large shopping centers, industrial plants, streets and plazas, transportation stations, and docks, etc.

High-pressure sodium lamps offer such advantages as high luminous efficiency, low power consumption, long service life, excellent ability to penetrate fog and haze, and lower attraction of insects. They are widely used for the lighting of roads, highways, airports, docks, shipyards, stations, plazas, intersections, industrial and mining operations, parks and courtyards, as well as for growing plants.

High-pressure mercury lamps are high-pressure discharge lamps that employ a glass bulb coated in phosphor; they generate a soft white light, and have a simple structure. Their advantages include low manufacturing costs, low maintenance costs, ability to directly replace incandescent lamps, high luminous efficiency, long service life, and high economic efficiency; they are suitable for use in industrial lighting, warehouse lighting, street lighting, as well as area and safety lighting. Because the light emitted by high-pressure mercury lamps contains no red wavelengths, objects illuminated by these lamps appear greenish; the lamps are therefore suitable only for the lighting of plazas and streets.

High-pressure xenon arc lamps rely on electricity discharged by xenon gas to emit light. Because these lamps contain the inert gas xenon, the gap between the excitation energy and ionization energy is small. Ultra-high pressure xenon short arc lamps offer high luminance, a small light-emitting area, good color rendering, color temperature close to that of sunlight, and stable color; they are widely used in movie projectors, sunlight simulators, printing plate production, copiers, and optical instruments. Because they operate by use of electronic ballasts, xenon arc lamps employ a different driving method than high-voltage gas-discharge lamps that use constant-wattage autotransformer (CWA) ballasts, such as metal halide lamps, high-pressure sodium lamps, and high-pressure mercury lamps.

According to American National Standards Institute (ANSI) standards, high-intensity discharge lamps (HIDs), including metal halide lamps, high-pressure sodium lamps, and high-pressure mercury lamps, must employ constant-wattage autotransformer (CWA) ballasts, which are commonly known as CWA ballasts and are also referred to as peak lead (magnetic leakage and voltage-up type) ballasts. Depending on the application, a ballast contains a film capacitor with appropriate capacitance, and may or may not contain a latch.

There are currently several hundred million HIDs in the United States with CWA ballasts that have been installed over the course of several decades. Two methods can be used to retrofit these HID lamps with high-efficiency, long-service-life LED lamps: One method is to retain the original ballast and directly replace the HID lamp with an LED lamp containing a built-in drive circuit. The other method is to completely remove the CWA ballast. The former lamp replacement method avoids complicated, dangerous elevated work and high labor expenses.

When light-emitting diode (LED) lamps are used to replace HID lamps, a driver must be employed to convert the alternating voltage and current from the ballast to direct voltage and current. FIG. 1 shows the connection of an existing CWA ballast and HID lamp. As shown in FIG. 1, the HID lamp is connected to the output end of a CWA ballast receiving AC public power, and the CWA ballast provides a constant power AC driver voltage to the HID lamp.

### SUMMARY OF THE DISCLOSURE

The technical problem that this present invention seeks to resolve is to convert the constant AC power of the output of an HID lamp's driving CWA ballast to the direct current needed to drive an LED lamp, while also reducing the ballast's power output to the LED lamp in order to reduce power consumption.

In order to solve the above-mentioned problem, a drive circuit for LED lamps adapted to replace high-intensity discharge lamps consists of a bridge rectifier and reactor element comprising: a drive circuit linking the high-intensity discharge lamp's constant-wattage autotransformer (CWA) ballast and an LED lamp. A current-limiting reactor element or shunt inductor is linked with the bridge rectifier for controlling the current flow in the bridge rectifier.

Thus, an aspect of the present invention is to provide a drive circuit for use with an LED lamp module having a positive terminal and a negative terminal. The drive circuit comprises:

a first input terminal, a second input terminal, a first output terminal and a second output terminal;

a bridge rectifier, and

a reactor element configured to control a current flow in the bridge rectifier, wherein the bridge rectifier consists of four rectifiers connected in a loop, the bridge rectifier having a first input, a second input, a first output and a second output, electrically connected to the first input terminal, the second input terminal, the first output terminal and the second output terminal, wherein

the first output terminal is arranged to connect to the positive terminal of the LED lamp module;

the second output terminal is arranged to connect to the negative terminal of the LED lamp module; and

the first input terminal and the second input terminal are arranged to separately connect to two output ends of a constant-wattage autotransformer ballast.

According to an embodiment of the present invention, the reactor element comprises an inductor, the inductor connected between the first input terminal (e) and the first input of the bridge rectifier.

According to an embodiment of the present invention, the reactor element comprises a capacitor, the capacitor connected between the first input terminal (e) and the first input of the bridge rectifier.

According to an embodiment of the present invention, the reactor element comprises a current-limiting element connected between the first input and the second input of the bridge rectifier.

According to an embodiment of the present invention, the current-limiting element comprises an inductor.

According to an embodiment of the present invention, the reactor element is configured to limit the current flow from the ballast to the LED lamp module.

The present invention will become apparent upon reading the description in conjunction with FIGS. 2-4.

### BRIEF DESCRIPTION OF THE DRAWINGS

FIG. 1 shows the connection of an existing CWA ballast and HID lamp.

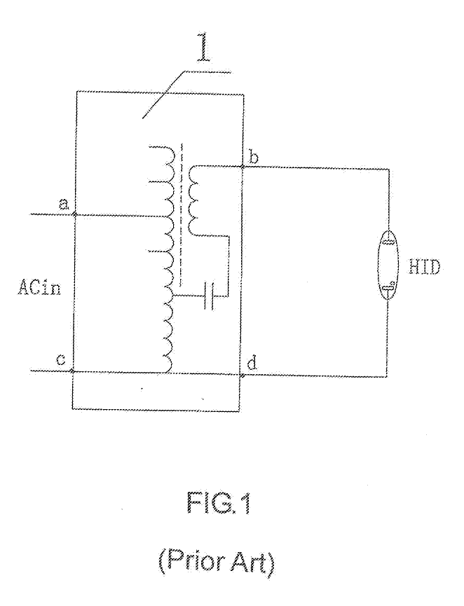

FIG. 2 shows an LED lamp drive circuit with a bridge rectifier in series with a current-limiting inductor, according to an embodiment of the present invention.

FIG. 3 shows an LED lamp drive circuit with a bridge rectifier in series with a current-limiting capacitor, according to an embodiment of the present invention.

FIG. 4 shows an LED lamp drive circuit with a bridge rectifier in parallel with a shunt inductor, according to an embodiment of the present invention.

### DETAILED DESCRIPTION OF THE INVENTION

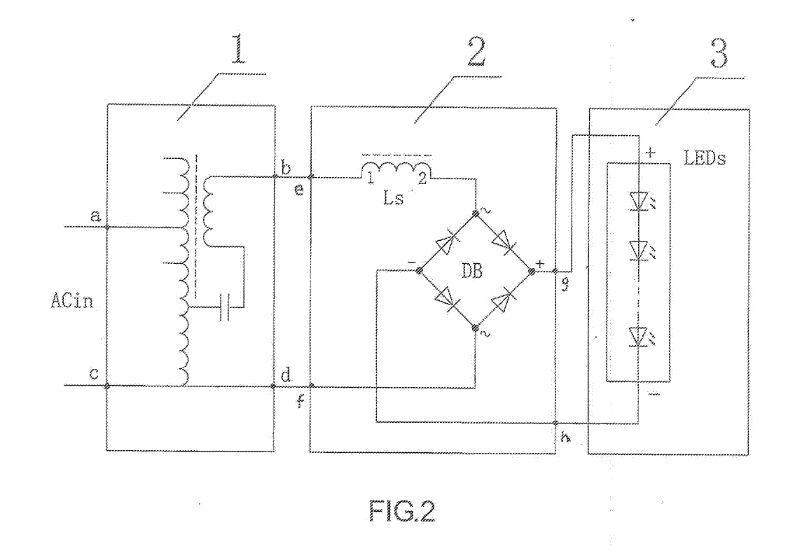

The present invention provides a drive circuit for LED lamps adapted to replace HID lamps. The drive circuit comprises a bridge rectifier and a reactor element. The drive circuit is arranged to electrically connect a high-intensity discharge lamp's constant-wattage autotransformer (CWA) ballast to an LED lamp module. The reactor element connected to the bridge rectifier is used to control the current flow in the bridge rectifier. As seen in FIGS. 2-4, the CWA ballast 1 has two AC input ends a and c and two output ends b and d. The input ends a and c are arranged for connection to an AC supply. The LED lamp module 3 has a positive terminal “+” and a negative terminal “−”. The drive circuit 2 has two input terminals e and f and two output terminals g and h. The input terminals e and f of drive circuit 2 are arranged to connect to the output ends b and d of the CWA ballast 1. The output terminals g and h are arranged to separately connect to the positive terminal “+” and the negative terminal “−” of the LED lamp module 3. The bridge rectifier DB in the drive circuit 2 has two AC input ends “˜”, a DC output end “+” and a DC output end “−”. The DC output ends “+” and “−” of the bridge rectifier DB are separately connected to the output terminal g and h of the drive circuit 2.

According to an embodiment of the present invention, the drive circuit 2 has a current-limiting inductor Ls to control the current flow in the bridge rectifier DB. As shown in FIG. 2, the current-limiting inductor Ls is connected in series between the input terminal e of drive circuit 2 and one of the AC input end “˜” of bridge rectifier DB. Another AC input end “˜” of bridge rectifier DB is connected to the input terminal f of the drive circuit 2. As the bridge rectifier DB converts the constant power AC voltage from the CWA ballast 1 to a DC voltage needed to drive the LED lamp module 3, the current-limiting inductor Ls limits the current output from the CWA ballast 1 to the LED lamp module 3.

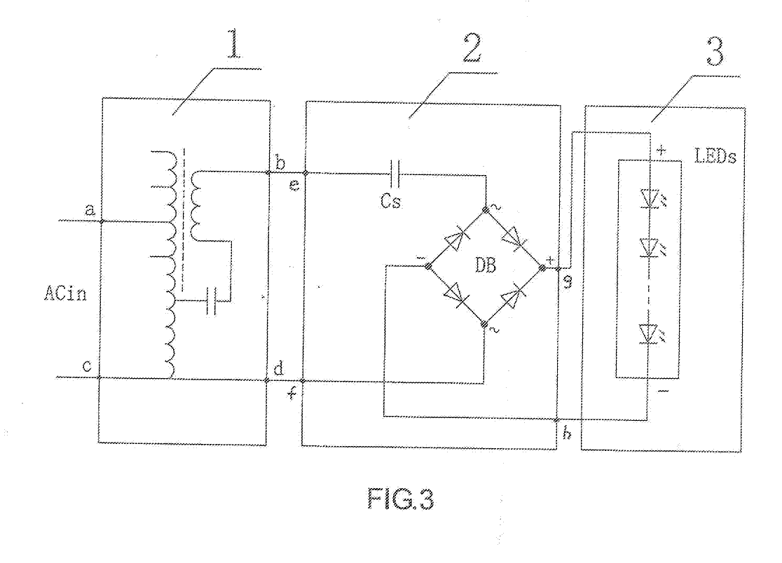

According to another embodiment of the present invention, the drive circuit 2 has a current-limiting capacitor Cs to control the current flow in the bridge rectifier DB. As shown in FIG. 3, the current-limiting capacitor Cs is connected in series between the input terminal e of drive circuit 2 and one of the AC input end “˜” of bridge rectifier DB. Another AC input end “˜” of bridge rectifier DB is connected to the input terminal f of the drive circuit 2. As the bridge rectifier DB converts the constant power AC voltage from the CWA ballast 1 to a DC voltage needed to drive the LED lamp module 3, the current-limiting capacitor Cs limits the current output from the CWA ballast 1 to the LED lamp module 3.

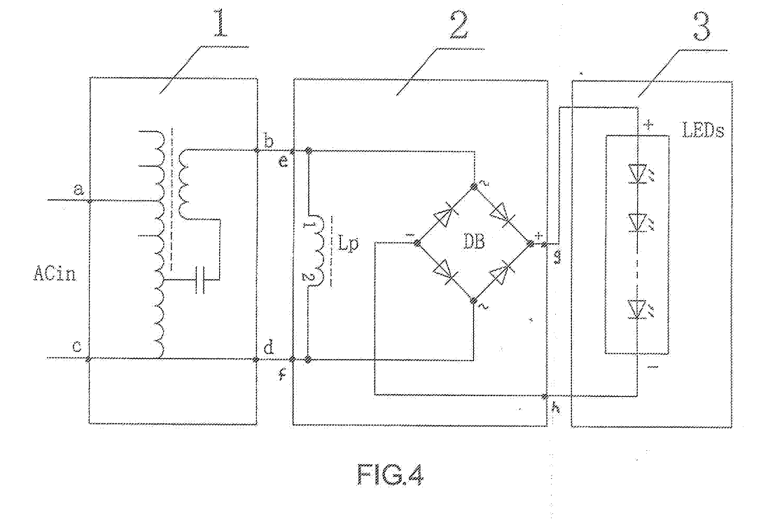

According to a different embodiment of the present invention, the drive circuit 2 has a parallel inductor Lp to control the current flow in the bridge rectifier DB. As shown in FIG. 4, the two AC input ends “˜” of bridge rectifier DB are separately connected to the input terminals e and f of drive circuit 2. Lead 1 of parallel inductor Lp is connected to an AC input end “˜” of bridge rectifier DB, and lead 2 of parallel inductor Lp is connected to another AC input end “˜” of bridge rectifier DB. As the bridge rectifier DB converts the constant power AC voltage from the CWA ballast 1 to a DC voltage needed to drive the LED lamp module 3, the parallel inductor Lp limits the current output from the CWA ballast 1 to the LED lamp module 3.

In summary, the drive circuit, according to embodiments of the present invention, comprises a bridge rectifier and a reactor element electrically connected to the bridge rectifier for controlling a current flow in the bridge rectifier. When a drive circuit is used to link an LED lamp module and a CWA ballast, the reactor element is used to limit the current output from the CWA ballast to the LED lamp module. The reactor element can be a series inductor, a series capacitor or a parallel inductor electrically connected to the bridge rectifier. The two AC input ends “˜” of the bridge rectifier are also referred to as a first input and a second input. The DC output ends “+” and “−” of the bridge rectifier are also referred to as a first output and the second output.

Thus, although the present invention has been described with respect to one or more embodiments thereof, it will be understood by those skilled in the art that the foregoing and various other changes, omissions and deviations in the form and detail thereof may be made without departing from the scope of this invention.

1. A drive circuit for use with a LED lamp module, the LED lamp module having a positive terminal and a negative terminal, said drive circuit comprising:
a first input terminal, a second input terminal, a first output terminal and a second output terminal;
a bridge rectifier, and
a reactor element configured to control a current flow in the bridge rectifier, wherein the bridge rectifier consists of four rectifiers connected in a loop, the bridge rectifier having a first input, a second input, a first output and a second output, electrically connected to the first input terminal, the second input terminal, the first output terminal and the second output terminal, wherein
the first output terminal is arranged to connect to the positive terminal of the LED lamp module;
the second output terminal is arranged to connect to the negative terminal of the LED lamp module; and
the first input terminal and the second input terminal are arranged to separately connect to two output ends of a constant-wattage autotransformer ballast.

2. The drive circuit according to claim 1, wherein the reactor element comprises an inductor, the inductor connected between the first input terminal and the first input of the bridge rectifier.

3. The drive circuit according to claim 1, wherein the reactor element comprises a capacitor, the capacitor connected between the first input terminal and the first input of the bridge rectifier.

4. The drive circuit according to claim 1, wherein the reactor element comprises a current-limiting element, the current-limiting element connected between the first input and the second input of the bridge rectifier.

5. The drive circuit according to claim 4, wherein the current-limiting element comprises an inductor.

6. The drive circuit according to claim 1, wherein the reactor element is configured to limit the current flow from the ballast to the LED lamp module.
